(19) United States
(12) Patent Application Publication
(10) Pub. No.: US 2024/0342052 A1
(43) Pub. Date: Oct. 17, 2024

(54) Anal Plug with Tail Attachment

(71) Applicants: Patrick Conwell, West Seneca, NY (US); Victoria Conwell, West Seneca, NY (US)

(72) Inventors: Patrick Conwell, West Seneca, NY (US); Victoria Conwell, West Seneca, NY (US)

(21) Appl. No.: 18/623,553

(22) Filed: Apr. 1, 2024

Related U.S. Application Data
(60) Provisional application No. 63/458,963, filed on Apr. 13, 2023.

(51) Int. Cl. A61H 19/00

(52) U.S. Cl. CPC A61H 19/44

(57) ABSTRACT

An anal plug and system for attaching tails to anal plugs are disclosed. The anal plug is designed for secure placement and ornamental customization. The anal plug features a tip, bulb, neck, and a modified base with anchoring capabilities, connected to a main connector with a mount for attaching ornamental tails or adornments to be worn on the lumbar spine. The design improves visual association with natural animal tails and enhances sanitation and stability, with options for tail detachability and ergonomic customization.

### CROSS-REFERENCE TO RELATED APPLICATIONS

This application claims priority to U.S. Provisional Application having Ser. No. 63/458,963, filed on Apr. 13, 2023, the entire disclosure of which is hereby incorporated herein by reference.

### BACKGROUND

The modern sex toy industry, characterized by rapid innovation and a wide range of products aimed at enhancing user experience, has seen a substantial interest in products that combine functionality with unique design elements. Many individuals use anal plugs for pleasure and other reasons. In some cases, individuals will use an anal plug having an animal tail attached to it for cosplay and aesthetic purposes. Anal plugs, in particular, represent a significant niche within this industry, attracting consumers through their combination of sexual pleasure functionality and aesthetic appeal. These products often incorporate cosplay and thematic elements, with designs featuring attached animal tails being notably popular for their role in facilitating immersive role-play and fantasy. Despite the broad range of designs aimed at balancing comfort, safety, ease of use, and visual appeal, there exist inherent challenges that limit user satisfaction with current offerings.

One primary limitation of existing designs is their failure to achieve an aesthetic appearance that aligns with the more appealing visual of a tail on your lower back, specifically the lumbar at L4. The tails on the anal plug do not give a natural or realistic appearance. Traditional anal plugs have a simple mount or attachment of a tail right at the base of the anal plug. The tail doesn't hang in a realistic manner and hangs from the anal plug in an unbecoming manner. This unnatural appearance detracts from the overall aesthetic appeal and realism, directly influencing user satisfaction. Moreover, the conventional design's proximity of the tail attachment to the anal orifice raises significant sanitary concerns, as contact with bodily fluids during use complicates cleaning and maintenance efforts-increasing the risk of contamination and material degradation over time.

Thus, it would be desirable to have an anal plug that has the tail attachment point that is placed at and protrudes from the upper tail bone/lower lumbar spine, rather than at a lower point which is often too close to the actual anal plug. This will result in an animal tail that is much more aesthetically pleasing as it is closer to where an animal tail would naturally appear from.

What is needed is a novel approach to the design and attachment method of tails on anal plugs that successfully addresses the shortcomings of current models. Such an innovation should prioritize an anatomically realistic positioning of the tail to enhance the user's role-play and aesthetic experience, while also considering the importance of ease of cleaning and maintenance to uphold sanitary standards. Additionally, advancements in material selection and design should contribute to an optimal balance between structural integrity, user comfort, and visual appeal. This new approach must aim to fill the existing gap within the sex toy industry, providing users with a product that not only meets but exceeds their expectations in functionality, aesthetic, and hygiene.

### FIELD

The present disclosure relates to the field of personal pleasure devices, specifically an improved design of anal plugs targeting aesthetic enhancements and sanitation improvements. This design is particularly focused on addressing the needs and preferences of the cosplay community and those who desire aesthetic integration of animal tails with such devices. Through extensive experimentation resulting in careful component arrangement, material selection, and attachment methods, this invention aims to offer a product that is both visually appealing and hygienically superior to existing alternatives in the market.

### SUMMARY

Accordingly, it is the subject of this invention to provide an anal plug having a tail attachment point near the upper tail bone/lower lumbar spine. In particular, the new shape of the anal plug and tail attachment provides the benefit of moving the tail to a new location. From an aesthetic standpoint, the tails look much better when positioned near the upper tail bone. Moreover, the placement of the tail away from any orifices provides a more sanitary experience.

In one aspect, the present invention introduces a novel anal plug design distinguished by aesthetic enhancements and sanitation improvements, specifically tailored for the cosplay community and individuals desiring aesthetic designs incorporating animal tails. This invention addresses the need for a more realistic representation and hygienic application of animal tail anal plugs by innovating the method of attaching tails and the location of the attached tails, thereby enhancing both the visual appeal and the sanitary aspects of such products.

Through the meticulous design process, by focusing on the technical, aesthetic, and material components, the invention differentiates itself from existing solutions by offering an improved user experience through a viable product design having an aesthetic presentation and enhanced sanitation.

In an embodiment, the anal plug comprises several critical components, including the tip, bulb, neck, modified base, base side, base connector, main connector, core, and an attachment point strategically designed for optimal aesthetics and functionality. Each component is engineered with precision to fulfill its role in ensuring user comfort, stability of the plug during use, and a hygienic and realistic connection of the tail to the user's body.

Furthermore, the selection of materials for the anal plug fabrication reflects a commitment to usability, comfort, and environmental considerations. Platinum cure silicone provides a balance between flexibility and firmness, is utilized for the body of the plug. For the mount and the core (of the main connector), the choice between thermoplastic polyurethane plastic (TPU) and acrylonitrile butadiene styrene (ABS) plastic provides durability and the ability to bare weight while still holding the tail flush to the body without any other support.

The novel attachment point for the tail is a primary innovation, significantly improving the aesthetic appeal by mimicking the natural emergence point of animal tails. This design advancement not only bolsters the realism for cosplay enthusiasts but also elevates sanitary standards by minimizing direct contact of the tail with bodily orifices. The invention overcomes previous challenges and innovates through stability and material enhancements, making this anal plug a significant advancement in the sex toy industry that caters to both aesthetic desires and sanitary requirements of users.

Through extensive experimentation that resulted in a detailed design, innovative material selection, and a focus on user-centric enhancements, this new anal plug with tail attachment emerges as a groundbreaking product in the sex toy market. It addresses both aesthetic and hygienic considerations, providing a unique and improved user experience. This invention represents a valuable addition to the industry, contributing significantly to the advancement of products designed for aesthetic pleasure and sanitary use.

In one embodiment, an anal plug is provided comprising a tip capable of being inserted into a body; a bulb positioned immediately after the tip capable of holding the anal plug in place after insertion; a neck following the bulb; a modified base connected to the neck and wherein the modified base includes a base side capable of anchoring the anal plug at a point on or near the perineum; a base connector that connects the modified base to a first end of a main connector; a mount capable of attaching an ornamental tail or adornment is positioned at a second end of main connector. The mount further comprises a mount base embedded into the main connector and connected to a mount top that is external to the main connector and wherein the mount top is larger in width than the mount base such that an ornamental tail or adornment can be secured between the mount top and the main connector. Further, the base side is heart-shaped or teardrop-shaped and the base connector includes a curvature matching the natural anatomy of the human body and terminated in the lumbar region of the spine. The anal plug is fabricated from platinum cure silicon. The anal plug of further includes a core and the mount and core of the anal plug are constructed from thermoplastic polyurethane plastic (TPU) or acrylonitrile butadiene styrene (ABS) plastic.

### BRIEF DESCRIPTION OF THE DRAWINGS

FIG. 1 is a side view of an anal plug device comprising a plug portion (20) with a tip (22), a bulb (24), and a neck (26), along with a modified base (28) featuring a main connector (30) and a base connector (32), and a separate mount (40) with a mount base (40a) and mount top (40b), shown in a fully assembled form.

FIG. 2 is a perspective view of an embodiment of an anal plug assembly showing the anal plug (10) with a tip (22), bulb (24), neck (26), and a modified base (28), as well as depicting a main connector (30) and base connector (32) configured to attach to a mount (40).

FIG. 3 is a perspective view of an anal plug showing a modified base (28), upper end (34), base connector (32), and core (36).

FIG. 4 is a cross section of an anal plug depicting the core (36)

### DETAILED DESCRIPTION

In one embodiment, an anal plug is disclosed having a tip, bulb, neck, modified base, base side, base connector, main connector, and attachment point. Typically, an anal plug includes, from top, a tip, bulb, neck, and base. The tip is shaped this way to assist with insertion, while the base is present to prevent the anal plug from going all the way into the body. The base may have different shapes such as a heart-shape or teardrop-shaped.

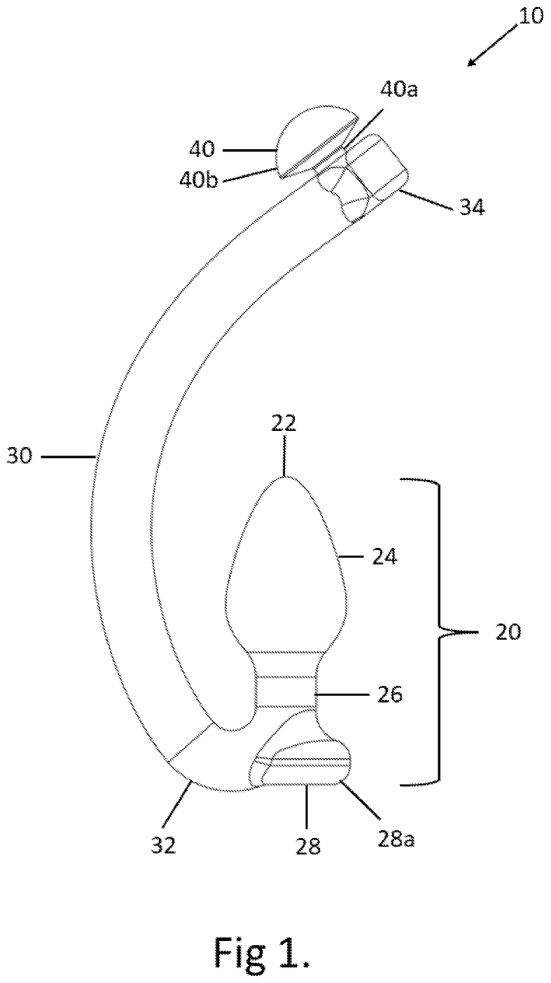

As shown in FIG. 1, the anal plug 10 of the present disclosure includes plug portion 20 having a tip 22, bulb 24, neck 26, and modified base 28. Most anal plugs include a symmetrical base, but the anal plug 10 of the present disclosure has a modified base 28, wherein one side is a base side 28a having a circular or heart-shape configuration and herein the other side is main connector 30. When in use, base side 28a, will be near or in contact with the perineum. The other side of the modified base 28 is a main connector 30 that attaches to a main connector 30, which includes mount 40 at an upper end 34. When in use, main connector 30 will be in contact with the area behind the anus. Critically, the base connector 32 is a u-bend shape that sets a trajectory for main connector 30 to sit on the body and place the tail mount 34 and 40 on the lumbar snuggly and without drooping.

Main connector 30 is shaped to move slightly down and away from modified base 28 and connects to main connector 30, which has a convex, upward shape that ends at upper end 34. On one side of main connector 30, adjacent to upper end 34 is mount 40. Mount 40 is shaped so as to be able to connect a tail or any other suitable adornment. In one embodiment, mount 40 is shaped similar to a mushroom wherein the mount base 40a is smaller than the mount top 40b. In one embodiment, mount base 40a is attached to main connector 30 at or near upper end 34. In a preferred embodiment, mount base 40a is embedded or inserted into main connector 30 at point 36 which has a recess capable of receiving mount base 40a.

Mount 40 is suitable for attaching a tail (not shown) or another ornamental piece (not shown). In certain embodiments, the tail is not permanently attached to the device and may be exchanged by taking the tail off of mount 40 and adding a different tail. In this way, different tails or ornamental pieces may be used on the same device.

In preferred embodiments, anal plug 10 is made from platinum cure silicone. In a preferred embodiment, the platinum cure silicone has a durometer of Shore 30A. In some embodiments anal plug 10 may be different colors, wherein the color is supplied by Mica pigments.

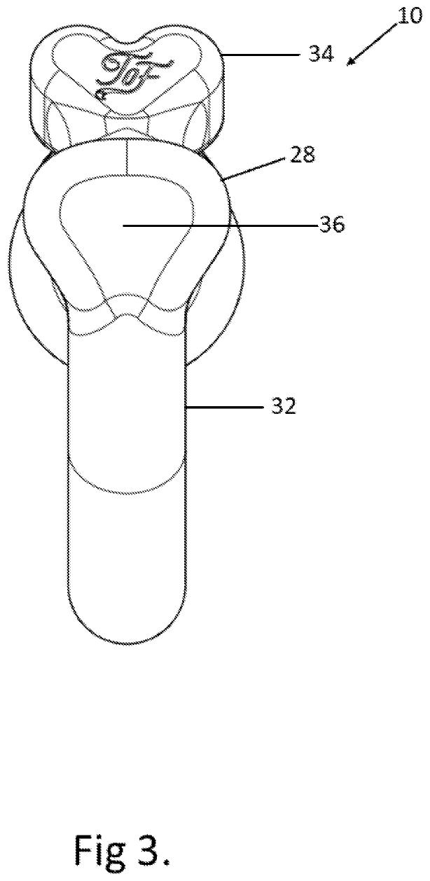

Preferably, mount 40 and core 36 (FIG. 3) of anal plug 10 are made of a thermoplastic polyurethane plastic (“TPU”). In another embodiment, acrylonitrile butadiene styrene (“ABS”) plastic may be substituted for the TPU. While it is preferable that core 10 is plastic, in other embodiments, any suitable material may be used for the core. Any suitable material made be used for any of the components of anal plug 10. Without intending to be bound by theory, it is believed that core 36 provides additional structure and stability to anal plug 10 and connector 30 while also providing the required flexibility for insertion of the device.

From an engineering standpoint, many structural challenges were overcome to create anal plug One of the biggest issues was designing a load bearing device that would not slip or move excessively during use, thereby ruining the experience or fantasy. This was achieved after many trials by “over molding” silicone onto a flexible yet supportive plastic core that could also be used for mounting the fabric tail. That is, a silicone layer is placed over the supportive plastic core.

Anal plug 10 also includes modified base 28, which can be thought of as a “booty stopper”. In one embodiment, modified base 28 (in combination with base side 28a) is heart-shaped or teardrop-shaped and serves as a platform that provides an anchor point as well as a stopper preventing the main connector 30 from slipping deeper into the anal cavity than desired. It is noted that without modified base 28, anal plug 10 may slip or shift around too much. The slipping of the anal plug 10 may cause potential discomfort, but may also significantly ruin the experience or fantasy by moving the tail off the tailbone and leaving it free floating.

In an embodiment, the components of anal plug 10 is made from a plastic mold. In another embodiment, the components of anal plug 10 are 3D printed. The 3d printed components are used inside of the molds which is where the over molding occurs.

In further detail, FIG. 1 shows a side view of an anal plug 10 in accordance with certain embodiments of the current invention. Anal plug 10 comprises a plug portion 20, a modified base 28, and a mount 40. Plug portion 20 includes a tip 22 at the distal end designed for ease of insertion, followed by a bulb 24 designed to secure the anal plug 10 in place once inserted. A neck 26 connects bulb 24 to modified base 28 and is shaped to allow the sphincter muscles to close around it, thereby stabilizing the anal plug 10 during use. The design of anal plug 10 is such that it may both comfortably rest between the buttocks and be gripped by them to maintain its position. This assists in keeping the anal plug in place.

The materials chosen for the construction of anal plug 10 are not depicted but include platinum cure silicone for plug portion 20 and either thermoplastic polyurethane plastic or acrylonitrile butadiene styrene plastic for core 36 and mount 40, affording a balance of flexibility and firmness, durability, and an aesthetic appeal due to its ability to support accessories with various weights and lengths.

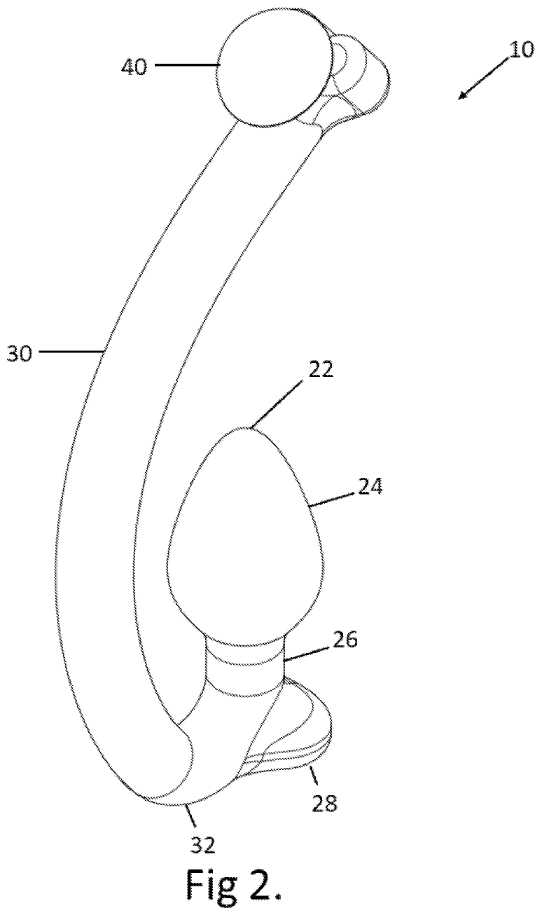

FIG. 2 shows an embodiment of an anal plug 10, demonstrating the spatial relationship and configuration of various integral components that constitute the device. This embodiment exhibits a contiguous design that includes a tip 22, a bulb 24, a neck 26, and a modified base 28, which altogether form the anal plug. Extending from the modified base 28 and main connector 30 is a main connector 30, which serves the primary function of attaching to a mount 40. A main connector 30 is also depicted in proximity to the main connector 30, and together they function collaboratively to secure the mount 40 to the modified base 28.

The tip 22 is illustrated as the foremost part of the anal plug 10, designed to provide ease of insertion. Adjacent to the tip 22 is the bulb 24, which is crafted to secure the device in place once inserted by providing an expansion of width immediately following the tip 22. Proceeding from the bulb 24 is the neck 26, delineating a slender profile that allows for the natural closure of sphincter muscles around it. The neck 26 connects to the modified base 28, which diverges from conventional anal plug bases by integrating an innovative base side 28a and main connector 30.

The main connector 30 is shown as a structural element that projects outwardly from the modified base 28. Its form is configured to provide a stable and secure attachment for the mount 40. In close association with the main connector 30, the main connector 30 is also visible and is purposed to reinforce the connection between the mount 40 and the anal plug 10, ensuring its proper positioning and overall stability.

Base side 28a is a component that has a geometric configuration that encompasses both polygonal and heart-shaped features. This component is structured to integrate the aesthetics and functional attributes of a heart shape, including but not limited to, symmetrical lobes at the top portion converging into a pointed base at the bottom, within the confines of a polygonal framework. Base side 28a is fabricated to maintain structural integrity and material efficiency while serving its intended utility in the assembly or mechanism of which it is part. The delineation of base side 28a as possessing both polygonal and heart-shaped characteristics allows for a versatile application in various contexts requiring such geometric and aesthetic considerations, while preventing anal plug 10 from slipping out of place.

The depicted elements of the anal plug 10 are designed to synergize, allowing for a seamless connection between the anal plug 10 and the modified base 28. The base side 28a contours around the main connector 30, adding structural integrity while providing a platform for the attachment of additional decorative or functional elements. In particular, the base side 28a defines the peripheral shape and appearance of the modified base 28 when viewed from the exterior.

FIG. 2 focuses on the components of the anal plug 10 that contribute to its attachment and stability features. These features are part of the broader context of providing a reimagined means to affix tails to the device, enhancing the user experience in terms of both visual appeal and hygiene. The depiction presented does not limit the scope to any particular tail design or attachment method, thereby maintaining the broad applicability of the claimed invention.

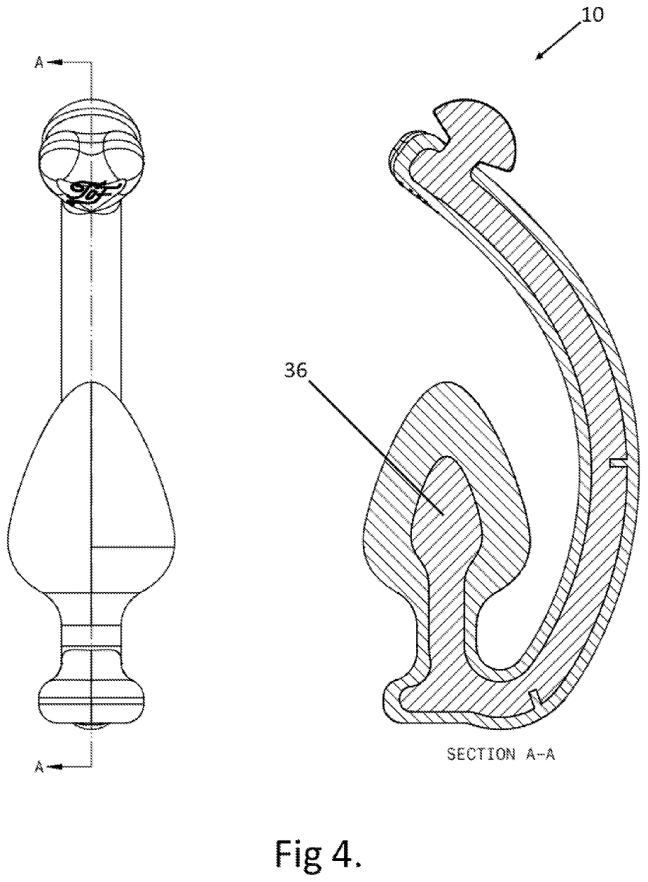

FIG. 3 shows a perspective view of an exemplary embodiment of an anal plug 10 featuring a modified base 28. Core 36 can be seen. FIG. 4 depicts a cross-section A-A better illustrating the core 36, which represents the internal structural element that is incorporated within the main connector 30 to ensure rigidity and stability, while also maintaining comfort during use. Core 36 is made of TPU or PLU and provides structural integrity of the anal plug 10. It supports the overall structure, enhancing the strength of the anal plug 10, and allows for safe and comfortable insertion and retention in use. The design and materials of core 36 contribute to the flexibility and firmness of the anal plug 10, as dictated by the requirements for usability and consumer comfort.

Through the arrangement of these components, a stable and hygienic platform is formed, allowing for the attachment of various accessories, in particular, those designed for use in the cosplay community. The design of the modified base 28, in conjunction with the core 36 and main connector 30, facilitates the improvement over existing anal plug designs by providing a more realistic positional attachment for tails and enhancing sanitation by distancing the attachment point from the body.

It will be appreciated by those skilled in the art that while the anal plug with tail attachment has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

1. An anal plug comprising: a tip capable of being inserted into a body; a bulb positioned immediately after the tip capable of holding the anal plug in place after insertion; a neck following the bulb; a modified base connected to the neck and wherein the modified base includes a base side capable of anchoring the anal plug at a point on or near the perineum; a base connector that connects the modified base to a first end of a main connector; a mount capable of attaching an ornamental tail or adornment is positioned at a second end of main connector.

2. The anal plug of claim 1, wherein the mount further comprises a mount base embedded into the main connector and connected to a mount top that is external to the main connector.

3. The anal plug of claim 2, wherein the mount top is larger in width than the mount base such that an ornamental tail or adornment can be secured between the mount top and the main connector.

4. The anal plug of claim 1, wherein the base side is heart-shaped or teardrop-shaped.

5. The anal plug of claim 1, wherein the base connector includes a curvature matching the natural anatomy of the human body and terminated in the lumbar region of the spine.

6. The anal plug of claim 1, wherein the anal plug is fabricated from platinum cure silicone.

7. The anal plug of claim 1, wherein the anal plug further includes a core.

8. The anal plug of claim 6, wherein the anal plug further includes a core.

9. The anal plug of claim 7, wherein the mount and core of the anal plug are constructed from thermoplastic polyurethane plastic (TPU).

10. The anal plug of claim 7, wherein the mount and core of the anal plug are constructed from acrylonitrile butadiene styrene (ABS) plastic.

11. The anal plug of claim 9, wherein the anal plug is fabricated from platinum cure silicone.

12. The anal plug of claim 11, wherein the mount further comprises a mount base embedded into the main connector and connected to a mount top that is external to the main connector.

13. The anal plug of claim 12, wherein the mount top is larger in width than the mount base such that an ornamental tail or adornment can be secured between the mount top and main connector.

14. The anal plug of claim 13, wherein the base side is heart-shaped or teardrop-shaped.

15. The anal plug of claim 14, wherein the base connector includes a curvature matching the natural anatomy of the human body and terminated in the lumbar region of the spine.

16. The anal plug of claim 10, wherein the anal plug is fabricated from platinum cure silicone.

17. The anal plug of claim 16, wherein the mount further comprises a mount base embedded into the main connector and connected to a mount top that is external to the main connector.

18. The anal plug of claim 17, wherein the mount top is larger in width than the mount base such that an ornamental tail or adornment can be secured between the mount top and main connector.

19. The anal plug of claim 18, wherein the base side is heart-shaped or teardrop-shaped.

20. The anal plug of claim 19, wherein the base connector includes a curvature matching the natural anatomy of the human body and terminated in the lumbar region of the spine.
